(19) United States
(12) Patent Application Publication
(10) Pub. No.: US 2017/0004499 A1
(43) Pub. Date: Jan. 5, 2017

(54) METHOD AND SYSTEM FOR CROSS-BORDER TRAVEL ALERTS

(71) Applicant: MASTERCARD INTERNATIONAL INCORPORATED, Purchase, NY (US)

(72) Inventors: Brad DICKINSON, O'Fallon, MO (US); Karen RANDELL, O'Fallon, MO (US); Jennifer ROSA, Moscow Mills, MO (US); Vandana GUPTA, Chesterfield, MO (US); Corey HIVELY, O'Fallon, MO (US); Navjot Singh SIDHU, Ardsley, NY (US)

(73) Assignee: MASTERCARD INTERNATIONAL INCORPORATED, Purchase, NY (US)

(21) Appl. No.: 14/790,282

(22) Filed: Jul. 2, 2015

(51) Int. Cl. G06Q 20/40; G06Q 20/32

(52) U.S. Cl. CPC G06Q 20/405; G06Q 20/3224

(57) ABSTRACT

A method for using mobile device roaming data to determine consumer geolocation for use in authorization decisions includes: storing an account profile, the profile including data related to a transaction account associated with a cardholder including an account identifier and geographic location; receiving a location notification, the notification including the account identifier and an updated geographic location of the cardholder, the updated geographic location being identified based on roaming data associated with a mobile communication device associated with the cardholder; receiving an authorization request associated with a payment transaction, the authorization request being a transaction message formatted based on associated standards and including the account identifier, transaction data, and a transaction location; determining an authorization decision for the payment transaction based on a correspondence between the updated geographic location and the transaction location; and forwarding the received authorization request and the determined authorization decision.

### FIELD

The present disclosure relates to cross-border travel alerts for use in authorization decisions of payment transactions, specifically the identification of a consumer's traveling to a new country based on roaming data of an associated mobile communication device and use thereof during the authorization of a subsequently initiated payment transaction.

### BACKGROUND

When a consumer uses a transaction account to fund a payment transaction, they expect that they will be able to successfully complete the transaction regardless of the time, merchant, or location at which they transact. At the same time, consumers also expect that fraudulent transactions will be denied, and their transaction account protected from misuse. However, ensuring that both of these desires are fulfilled can be difficult for many financial institutions. Traditionally, many financial institutions prohibit most, and sometimes all, transactions conducted outside of the borders of a consumer's home country or area, as a way to reduce fraud. Unfortunately, such practices can be frustrating for consumers that often travel outside of their home country, as they must repeatedly inform their financial institution of their itinerary, or else see transactions in the country they are visiting be declined.

A number of systems have been developed to try and improve the situation for consumers. Such systems often track the movement of the consumer based on the movement of an associated mobile communication device, such as a cell phone, and use the obtained location data to determine if a transaction should be authorized for a consumer when outside, and sometimes within, their home country. However, many of these systems identify the location of a consumer as part of the authorization process of a transaction. Such processes can unduly extend the authorization time of a transaction, and can only be performed if the consumer is in possession of their mobile device, if their mobile device is powered on, and if their mobile device has a sufficient connection to a mobile network.

Some systems try to avoid performing the location identification at the time of the transaction, in order to alleviate some of these problems. In these alternative systems, the mobile device is regularly pinged to identify its geographic location, and its latest location used during the authorization process. However, this can result in unnecessary network traffic, can be a drain on the power of the user's mobile communication device, and can also be inaccurate if a user travels to a new location between pings. In addition, many of these systems use the global positioning system (GPS) to identify a device's location. However, not every mobile device is capable of identifying its location using GPS, and, as a result, many devices are unable to be used in these systems and thus leave consumers unable to take advantage of the beneficial features.

Thus, there is a need for a technical solution to improve on the identification of a consumer's geographic location for use in authorization processes using a mobile communication device. Specifically, there is a need for a system where the geographic location of a mobile device can be identified upon entry into a new geographic area that does not require pinging of the mobile device, and while also using a technological solution that can be used with all types of mobile communication devices, and not limited based on the technology of the devices themselves.

### SUMMARY

The present disclosure provides a description of systems and methods for using mobile device roaming data to determine consumer geolocation for use in authorization decisions.

A method for using mobile device roaming data to determine consumer geolocation for use in authorization decisions includes: storing, in an account database, an account profile, wherein the account profile includes data related to a transaction account associated with a cardholder including at least an account identifier and a geographic location; receiving, by a receiving device, a location notification, wherein the location notification includes at least the account identifier and an updated geographic location of the cardholder, the updated geographic location being identified based on roaming data associated with a mobile communication device associated with the cardholder; receiving, by the receiving device, an authorization request associated with a payment transaction, wherein the authorization request is a transaction message formatted based on one or more associated standards and includes at least the account identifier, transaction data, and a transaction location; determining, by a processing device, an authorization decision for the payment transaction based on at least a correspondence between the updated geographic location and the transaction location; and forwarding, by a transmitting device, at least the received authorization request and the determined authorization decision.

A system for using mobile device roaming data to determine consumer geolocation for use in authorization decisions includes: an account database configured to store an account profile, wherein the account profile includes data related to a transaction account associated with a cardholder including at least an account identifier and a geographic location; a receiving device configured to receive a location notification, wherein the location notification includes at least the account identifier and an updated geographic location of the cardholder, the updated geographic location being identified based on roaming data associated with a mobile communication device associated with the cardholder, and an authorization request associated with a payment transaction, wherein the authorization request is a transaction message formatted based on one or more associated standards and includes at least the account identifier, transaction data, and a transaction location; a processing device configured to determine an authorization decision for the payment transaction based on at least a correspondence between the updated geographic location and the transaction location; and a transmitting device configured to forward at least the received authorization request and the determined authorization decision.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for using mobile device roaming data in authorization decisions in accordance with exemplary embodiments.

FIG. 2 is a block diagram illustrating the processing server of FIG. 1 for using mobile device roaming data in authorization decisions in accordance with exemplary embodiments.

FIG. 3 is a flow diagram illustrating a process for registration of a transaction account and mobile device for use in the system of FIG. 1 in accordance with exemplary embodiments.

FIG. 4 is a flow diagram illustrating a process for making authorization decisions based on alerted movement of a consumer mobile device using roaming data in the system of FIG. 1 in accordance with exemplary embodiments.

FIG. 5 is a flow chart illustrating an exemplary method for using mobile device roaming data to determine consumer geolocation for use in authorization decisions in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

### System for Using Roaming Data for Authorization Decisions

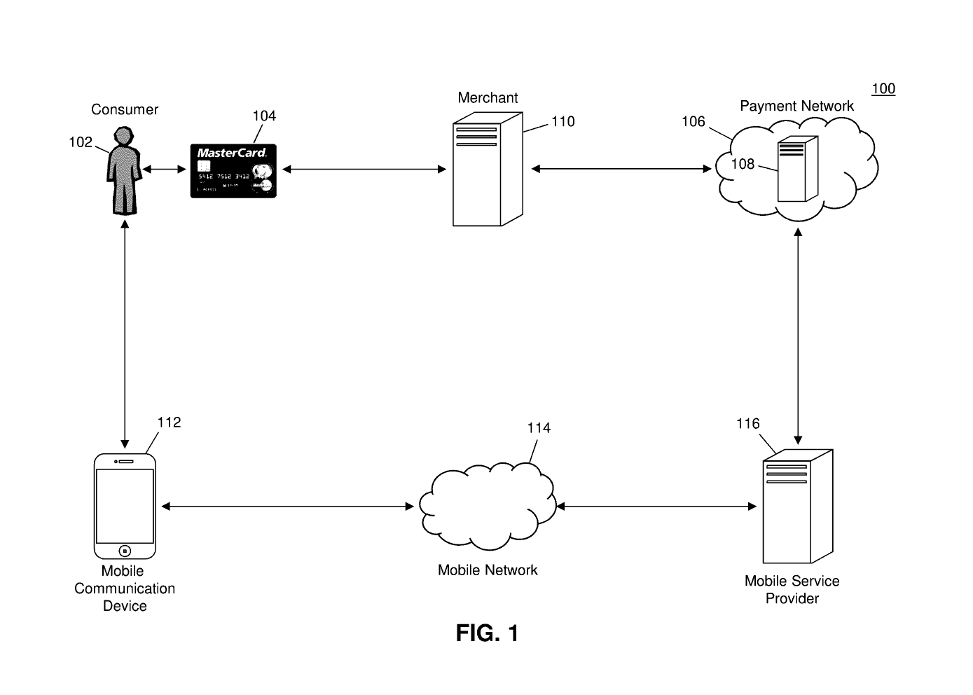

FIG. 1 illustrates a system 100 for the use of mobile device roaming data to identify a consumer geolocation for use in authorization decisions in subsequent consumer payment transactions.

In the system 100, a consumer 102 may conduct payment transactions to be funded by a transaction account via a payment card 104. The payment card 104 may be associated with the transaction account and may be presented to a merchant 110 during the course of a payment transaction to provide payment details for funding of the payment transaction using the associated transaction account. Traditionally, payment transactions conducted using the payment card 104 may be processed by a payment network 106 using traditional methods and systems that will be apparent to persons having skill in the relevant art. The payment network 106 may include a processing server 108. The processing server 108, discussed in more detail below, may be configured to determine authorization decisions for payment transactions conducted using the payment card 104 based on a consumer geolocation.

The consumer geolocation may be determined using a mobile communication device 112 associated with the consumer 102. The mobile communication device 112 may be a cellular phone, smart phone, personal digital assistant, smart watch, wearable or implanted computing device, tablet computer, notebook computer, laptop computer, or other suitable type of mobile computing device. The mobile communication device 112 may be configured to communicate with a mobile network 114, such as a cellular network, associated with a mobile network operator 116. As used herein, “mobile service provider” may refer to an entity configured to operate, maintain, or otherwise manage a mobile network (e.g., the mobile network 114) or any other entity associated with a mobile network, such as a third party entity configured to identify devices connected to a mobile network, communication the identity of devices to their home mobile network operator, send or receive data via a mobile network, etc., as well as any entity configured to provide services to computing devices (e.g., mobile communication devices 112) associated with a mobile network, such as data providers, application providers, media streaming services, etc.

When the consumer 102 leaves their home country or region with their mobile communication device 112, the mobile communication device 112 may connect with a new mobile network 114 outside of their home country or region. The new mobile network 114 may be a different mobile network 114 than the mobile network 114 in their home country, sometimes referred to as a “roaming” network. However, roaming data may include a geographic area defined as any demarcation significant to payment account transactions and/or the imposition of roaming charges by a cellular data and/or phone provider, such as countries, insofar as the country of origination of the transaction and often point of sale location is or are usually conveyed with a payment authorization and is often used to determine whether roaming charges apply, but other demarcations are envisioned, such as geographic areas that have different risk or fraud profiles. When roaming, the mobile communication device 112 can use the mobile network 114 operated by a roaming mobile network operator 116 for transmission of data, which may be subject to conditions set by the roaming mobile network operator 116, the home mobile network operator, etc.

When the mobile communication device 112 first connects to the roaming mobile network 114, the mobile network operator 116, or other entity associated with the roaming mobile network 114, may identify the mobile communication device 112 as connected with the roaming mobile network 114. The mobile communication device 112 can be identified by the roaming mobile network 114 using methods that will be apparent to persons having skill in the relevant art. The roaming mobile network 114 may gather data regarding the mobile communication device 112 and identification thereof as roaming data, and may provide the data to the mobile network operator 116 or other entity. The mobile network operator 116 may then analyze the roaming data to identify the geolocation of the mobile communication device 112. Methods and systems for identifying the geolocation of a mobile device using roaming data are discussed in more detail in U.S. Patent Publication No. 2014/0349610, entitled “Method and Apparatus to Provide Mobile Intelligence,” filed on May 21, 2013, which is herein incorporated by reference in its entirety.

The mobile network operator 116 may transmit the new geolocation of the mobile communication device 112 to the processing server 108 of the payment network 106. In some embodiments, the geolocation of the mobile communication device 112 may be identified upon entry of the mobile communication device 112 into a new geographic area, such as a new coverage area of the roaming mobile network 114, a new country, a new municipality, a new governmental district, etc. In some instances, the mobile network operator 116 may periodically (e.g., at a predetermined interval, each time new roaming data is obtained, entry into a different geographic area that has been identified by the payment network 106 as an area having a different fraud risk profile than the preceding geographic area, etc.) identify the geolocation of the mobile communication device 112, and may only transmit the geolocation to the processing server 108 if the mobile communication device 112 enters or leaves a geographic area. That is, the communication from the mobile network provider 116 may be limited to occur only when the mobile communication device 112 enters a new geographic area or departs from a preceding geographic area. For instance, the mobile network operator 116 may inform the processing server 108 of a new country when entered by the mobile communication device 112, but may refrain from additional updates regarding the geolocation until the mobile communication device 112 enters another new country or leaves the country. The geographic area may be determined by the payment network 106, and may be, for instance, a country or other government mandated demarcation, but also by statistical analysis of areas of greater or lesser risk of fraud.

By informing the processing server 108 only upon entry or exit of a geographic area, the processing server 108 may obtain the geolocation of the mobile communication device 112, and, by extension, the associated consumer 102 at a relevant time and without continuous pinging of the mobile communication device 112. Thus, the consumer's geolocation may be obtained without delaying or increasing the authorization process for a payment transaction, without unduly draining power of the mobile communication device 112, without the need for any specialized application program on the mobile communication device 112, and without requiring the consumer 102 to be in possession of the mobile communication device 112 around the time of the transaction. Further, by using roaming data, the geolocation of the mobile communication device 112 may be obtained without using GPS, and may therefore enable the present methods and systems to be used with a wider variety of mobile communication devices 112, thereby increasing adoption and convenience of consumers 102. Furthermore, because the mobile network operator 106 does not need to continuously update its databases of the mobile communication device 112 to route calls to the mobile communication device 112, the mobile network operator 116 can decrease processing. As a result, the methods and systems discussed herein may result in faster, more efficient authorization decisions that rely on consumer geolocation that can be performed with a wider variety of mobile communication devices 112 than in existing systems.

Once the processing server 108 has been informed that the consumer 102 has entered a new geographic area based on the identified geolocation of their associated mobile communication device 112, the processing server 108 may store the relevant information (e.g., the new geographic area) in an account profile associated with the consumer 102 and/or the payment card 104, as discussed in more detail below. When the consumer 102 conducts a payment transaction at a merchant 110 using the payment card 104, the processing server 108 may make an authorization decision based on, at least in part, the geographic location of the payment transaction and the obtained consumer geolocation. The geographic location of the payment transaction may be included in an authorization request or other transaction message received by the payment network 106 during processing of the payment transaction.

The transaction message may be specially formatted pursuant to one or more standards governing messages associated with payment transactions, such as the International Organization for Standardization's ISO 8583 standard, and may include one or more data fields that include information indicating the geographic location of the transaction, such as a country code, street address, etc. of the merchant 110, a point of sale device, etc., or information that may be used in the identification of the geographic location, such as a merchant identification number that may be used to look up an associated geographic location in a lookup table by the processing server 108.

The authorization decision may be further based on additional data suitable for use in performing authorization decisions, such as fraud rules, transaction data, account data, merchant data, consumer data, product data, etc. For example, the processing server 108 may apply one or more fraud rules to the payment transaction to identify a potential likelihood of fraud for the payment transaction, such as based on additional transaction data. In such instances, the authorization decision may be based on both the geolocation and any additional determinations. In some cases, the processing server 108 may perform multiple authorization decisions, such as one based on each consideration, such as a geolocation decision and a separate fraud decision.

The authorization decision may be used by the processing server 108 and/or payment network 106 in the processing of the payment transaction. For example, the processing server 108 may provide the authorization decision along with the authorization request to a financial institution associated with the payment card 104 used in the payment transaction, for an approval determination for the transaction. In another example, the processing server 108 may return an authorization response indicating denial of the transaction if the authorization decision indicates denial (e.g., based on the transaction location being different from the consumer geolocation), without first waiting for a response from a financial institution. In such an instance, the processing server 108 may notify the financial institution of the denial, such that, for example, the financial institution may inform the consumer 102, place a hold on the payment card 104, etc. In some embodiments, the processing of the payment transaction subsequent to the authorization decision may be based on rules set forth by the payment network 106, the financial institution associated with the payment card 104, the consumer 102, the merchant 110, a financial institution associated with the merchant 110, or any other suitable entity.

### Processing Server

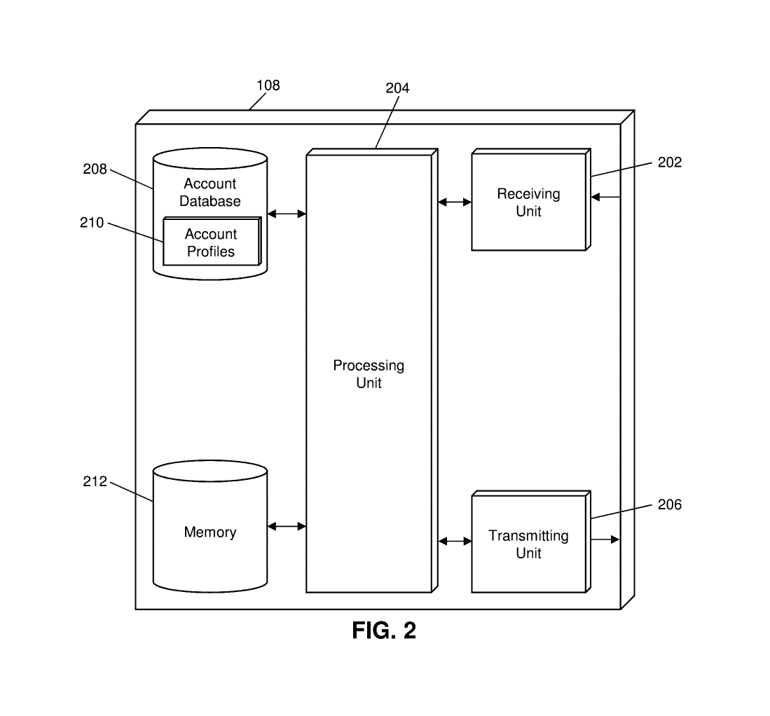

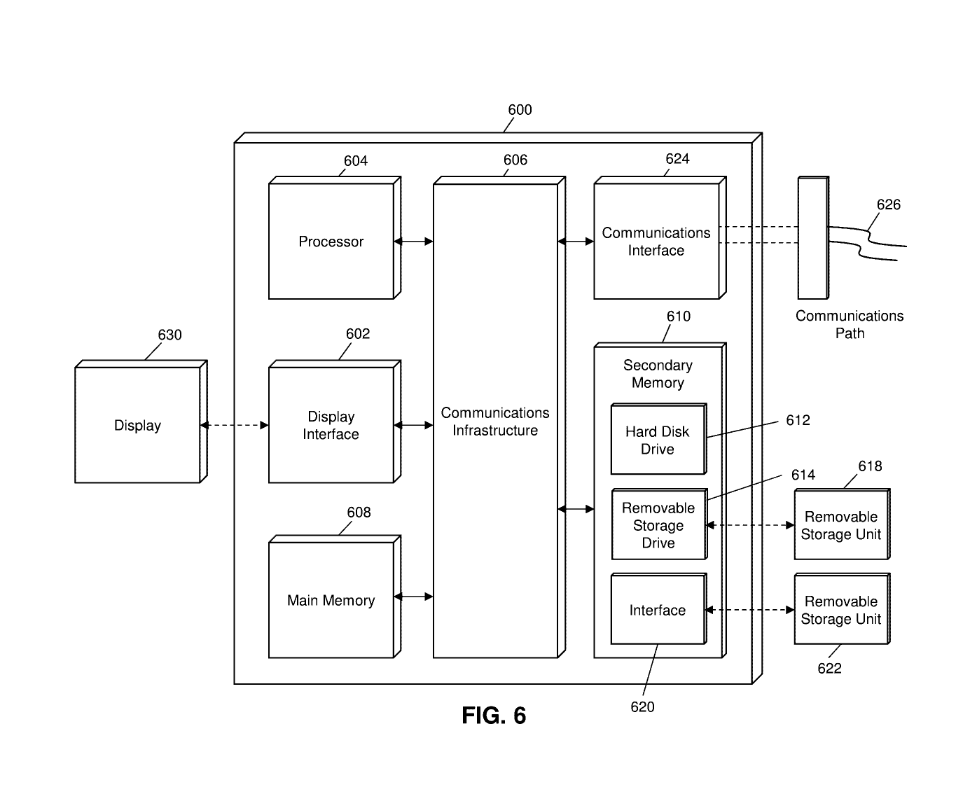

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 600 illustrated in FIG. 6 and discussed in more detail below may be a suitable configuration of the processing server 108.

The processing server 108 may include a receiving unit 202. The receiving unit 202 may be configured to receive data over one or more networks via one or more network protocols. The receiving unit 202 may receive geolocation data from the mobile network operator 116 or other suitable entity, may receive registration information from a consumer 102 and/or financial institution, such as an account identifier associated with a transaction account, a mobile communication device identifier, a current geolocation, etc. The receiving unit 202 may also be configured to receive transaction messages, which may be formatted pursuant to one or more standards and require the use of one or more specialized protocols for the receipt and reading thereof. In some instances, the transaction messages may be received from a separate computing device that is part of the payment network 106. In other instances, the transaction messages may be received by the receiving unit 202 for use by the payment network 106.

The processing server 108 may further include an account database 208. The account database 208 may be configured to store a plurality of account profiles 210. Each account profile 210 may include data related to a transaction account including at least an account identifier and a geographic location. The account identifier may be a unique value suitable for use in identifying the account profile 210 and/or related transaction account, such as a transaction account number, username, email address, phone number, device identifier (e.g., associated with the mobile communication device 112), or other suitable value. The geographic location may be a geographic location and/or area currently associated with the transaction account and/or a cardholder (e.g., the consumer 102) associated with the transaction account.

In some embodiments, the account profile 210 may further a device identifier associated with the mobile communication device 112 associated with the related transaction account and/or cardholder. The device identifier may be a unique value suitable for use in identification of the mobile communication device 112 and/or account profile 210, such as a registration number, serial number, media access control address, internet protocol address, phone number, email address, etc. The device identifier may be included in notifications received from the mobile network operator 116 that include a geolocation of the mobile communication device 112. In some instances, the notifications provided by the mobile network operator 116 may additionally, or alternatively, use the account identifier. In some embodiments, the device identifier and account identifier may be the same value.

The processing server 108 may also include a processing unit 204. The processing unit 204 may be configured to perform the functions of the processing server 108 discussed herein as will be apparent to persons having skill in the relevant art. The processing unit 204 may be configured to generate new account profiles 210 upon registration by a consumer 102, may update geolocations in account profiles 210 based on location notifications received by the receiving unit 202 from the mobile network operator 116, etc. The processing unit 204 may also be configured to perform authorization decisions for payment transactions. When a transaction message is received by the receiving unit 202, the processing unit 204 may identify an account identifier and transaction location included therein (e.g., using one or more associated standards) and may be identify an account profile 210 that includes the account identifier. The processing unit 204 may identify a correspondence between the transaction location and the geographic location included in the identified account profile 210 to make a determination regarding authorization of the received transaction message.

In some embodiments, the processing unit 204 may be configured to base the authorization decision on additional information, such as fraud rules, transaction data, account data, credit history, etc. In such embodiments, the processing unit 204 may use additional data included in the received transaction message and stored in the account profile 210, as well as additional sources of data, to determine the authorization decision. In some instances, if the processing unit 204 determines that a payment transaction should be denied based on the authorization decision (e.g., because the consumer 102 is not in the same geographic area as the payment transaction), the processing unit 204 may be configured to generate an authorization response for the payment transaction, which may be a transaction message indicating that the payment transaction is denied.

The processing server 108 may further include a transmitting unit 206. The transmitting unit 206 may be configured to transmit data over one or more networks via one or more network protocols. The transmitting unit 206 may be configured to transmit transaction messages using specially configured standards and communication protocols, such as forwarding authorization requests to financial institutions associated with transaction accounts, transmitting authorization responses to merchants 110 and/or associated financial institutions, etc. In some instances, the transmitting unit 206 may transmit an authorization decision as part of, or accompanying, a transaction message transmitted to a financial institution. For example, the authorization decision may be included in a data field included in an authorization request received by the processing server 108 and forwarded to an issuing financial institution for approval or denial.

The processing server 108 may also include a memory 212. The memory 212 may be configured to store data suitable for performing the functions of the processing server 108 discussed herein. For example, the memory 212 may store standards for reading and/or communicating transaction messages, geographic location and area associations, rules and/or algorithms for determining authorization decisions, fraud rules, notification standards and protocols, etc. Additional data that may be stored in the memory 212 will be apparent to persons having skill in the relevant art.

In some embodiments, the processing server 108 may include additional components, and/or the components included in the processing server 108 as illustrated in FIG. 2 and discussed herein may be configured to perform additional and/or alternative functions. For example, in some instances, the processing server 108 may be configured to perform additional functions of the payment network 106, such as for the processing of payment transactions. In such an instance, the processing server 108 may include additional components, or the components illustrated in FIG. 2 and discussed herein may be configured to perform additional functions to perform those functions of the payment network 106, as will be apparent to persons having skill in the relevant art.

### Process for Account Registration

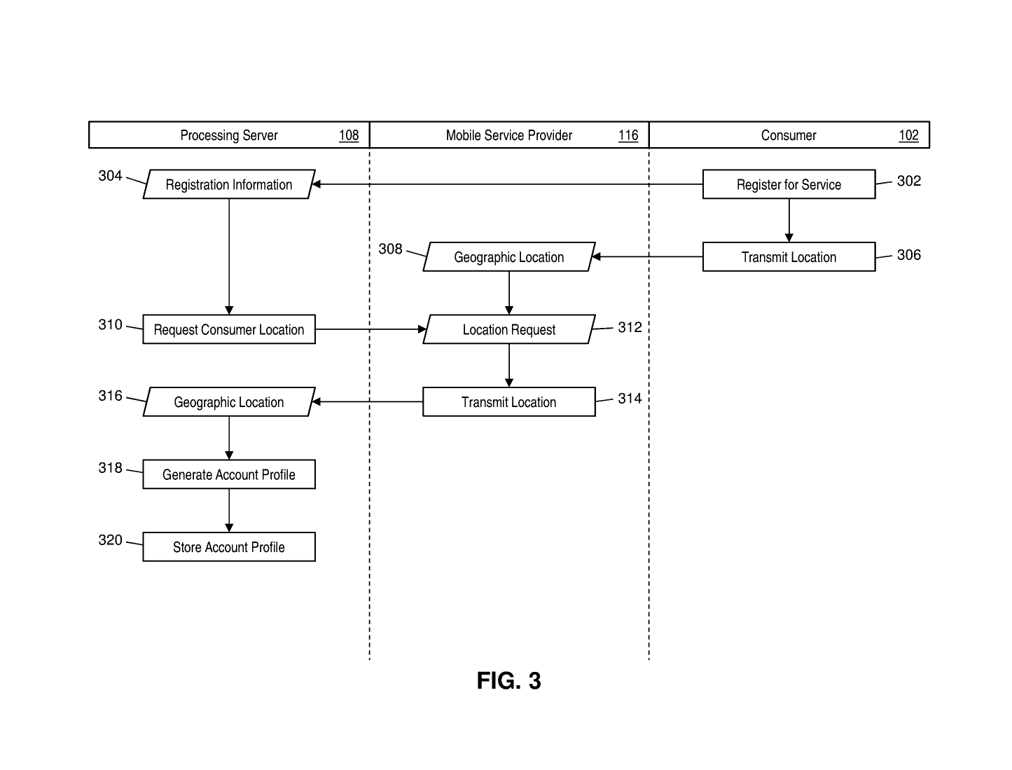

FIG. 3 illustrates a process for the registration of a transaction account for use in the methods and systems discussed herein for performing authorization decisions based on consumer geolocations obtained using mobile device roaming data.

In step 302, the consumer 102 may register for the service provided by the processing server 108. The registration may be performed using the mobile communication device 112, a separate computing device, by telephone, via e-mail, in person, via a financial institution (e.g., associated with the payment card 104), or other suitable method. As part of the registration, registration information may be submitted to the processing server 108 and received by the receiving unit 202 of the processing server 108, in step 304. The registration information may include at least an account identifier associated with a transaction account being registered by the consumer 102. In some embodiments, the registration information may also include a device identifier associated with a mobile communication device 112 indicated by the consumer 102 to be used to identify the consumer's geolocation. In some instances, the device identifier may be submitted to the processing server 108 directly by the mobile communication device 112, such as if the mobile communication device 112 is used to perform the registration.

In step 306, the consumer 102 may use their mobile communication device 112 to transmit its current geographic location to the mobile network operator 116 (e.g., via the mobile network 114). In some embodiments, the mobile network operator 116 may initiate identification of the geographic location of the mobile communication device 112 without the consumer 102 being required to perform any steps or functions. In step 308, the mobile network operator 116 may receive the identified geographic location of the mobile communication device 112. The geographic location may be identified based on connection of the mobile communication device 112 to the mobile network 114, such as by identification of a geographic location of a network access point (e.g., a cellular tower, network router, etc.) in communication with the mobile communication device 112, roaming data, etc. In some instances, steps 306 and 308 may be performed prior to steps 302 and 304, such as instances where the mobile network operator 116 may periodically obtain the geographic location of the mobile communication device 112.

In step 310, the transmitting unit 206 of the processing server 108 may transmit a request for the geographic location of the mobile communication device 112 to the mobile network operator 116. In step 312, the mobile network operator 116 may receive the request, which may include the account identifier and/or device identifier provided by the consumer 102 during registration. In step 314, the mobile network operator 116 may identify the geographic location obtained for the mobile communication device 112 associated with the received account and/or device identifier, and transmit the geographic location to the processing server 108. Alternatively or additionally, the mobile network operator 116 may transmit the geographic location to the processing server 108 when, and perhaps only when, the mobile communication device 112 has changed geographic areas, which may reduce processing of an authorization request by having the current geographic area in the account profile 210 for the consumer 102 when an authorization request is received, and perhaps by increasing privacy of the consumer by not implicitly indicating when transactions of a consumer 102 are occurring to the mobile network operator 116. In step 316, the receiving unit 202 of the processing server 108 may receive the geographic location.

In some embodiments, steps 310 and 312 may be optional steps. For example, in some embodiments the mobile network operator 116 may identify the geographic location of the mobile communication device 112 and transmit the geographic location to the processing server 108 without a request being provided by the processing server 108 (e.g., the location may be “pushed” to the processing server 108). For instance, the mobile network operator 116 may identify when the mobile communication device 112 has changed geographic areas and may notify the processing server 108 upon the change of the mobile communication device's new geographic area.

In step 318, the processing unit 204 of the processing server 108 may generate an account profile 210 for the consumer 102. The account profile 210 may be related to the transaction account associated with the account identifier provided by the consumer 102 and may include at least the geographic location received from the mobile network operator 116 in step 316. In some embodiments, the account profile 210 may include additional data submitted by the consumer 102, such as contact information, notification settings, etc. In some instances, the consumer 102 may provide account identifiers for multiple transaction accounts to which the consumer 102 wants their geographic location to be used in authorization decisions. In such instances, the account profile 210 may include a plurality of account identifiers, each account identifier being associated with a separate transaction account. In step 320, the processing unit 204 may store the generated account profile 210 in the account database 208 of the processing server 108.

### Process for Determining Authorization Decisions Based on Geolocation

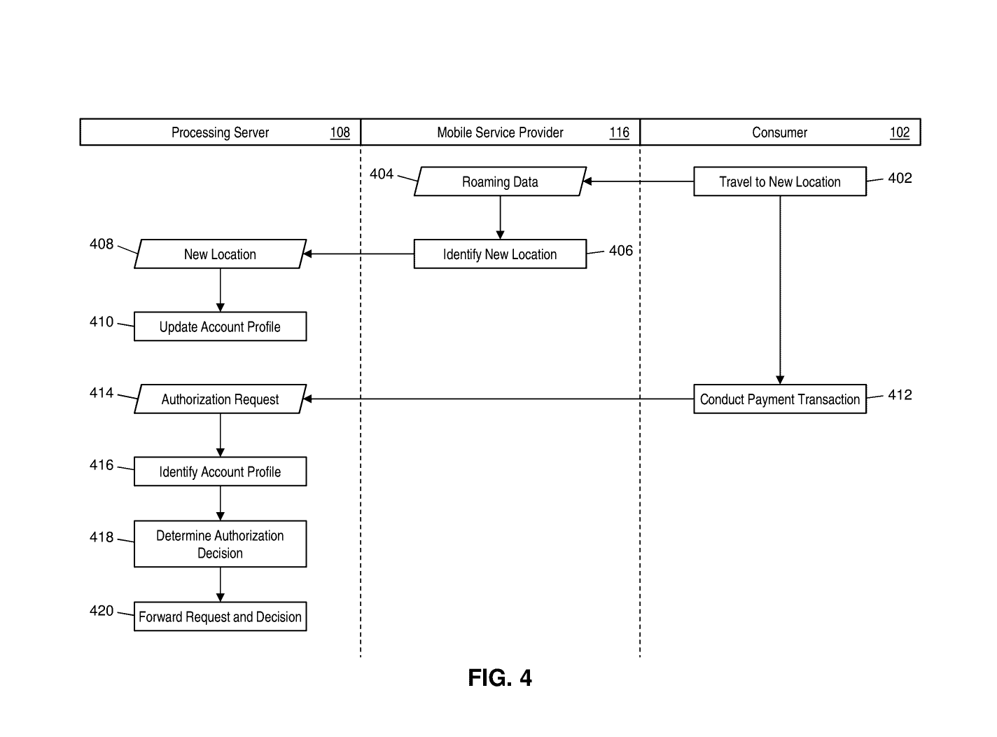

FIG. 4 illustrates a process of the system 100 of FIG. 1 for determining an authorization decision for a payment transaction based on a consumer's geolocation obtained using mobile device roaming data.

In step 402, the consumer 102, which has previously registered with the processing server 108 as illustrated in the process of FIG. 3 and discussed above (e.g., such that there is a corresponding account profile 210 stored in the account database 208 of the processing server 108), may travel to a location in a new geographic area with their mobile communication device 112. In step 404, the mobile network operator 116 may receive roaming data associated with the mobile communication device 112 as a result of the movement to the new geographic area, such as from the mobile network 114. In some instances, the roaming data may not be transmitted to the mobile network operator 116 unless the data indicates travel to a new geographic area. In other instances, the mobile network operator 116 may not continue to perform the process illustrated in FIG. 4 if the received roaming data does not indicate a geographic location in a new geographic area.

In step 406, the mobile network operator 116 may identify the new geographic location of the mobile communication device 112 using the roaming data. For instance, the roaming data may include a network access point to the mobile network 114 the identified and/or communicated with the mobile communication device 112. In such an instance, the mobile network operator 116 may identify a geographic location and/or area of the network access point to identify the geographic location and/or area of the mobile communication device 112.

The geographic location may be transmitted to the processing server 108, and received by the receiving unit 202 of the processing server 108 in step 408. The geographic location may be accompanied by an account identifier and/or device identifier associated with the mobile communication device 112. In step 410, the processing unit 204 may identify the account profile 210 stored in the account database 208 that includes the account identifier and/or device identifier accompanying the geographic location and may update, in the account profile 210, the geographic location currently associated with the related transaction account(s).

In step 412, the consumer 102 may conduct a payment transaction at a merchant 110 using a payment card 104 associated with a transaction account related to the account profile 210 (e.g., previously registered with the processing server 108). In some instances, the payment transaction may conducted temporally separate from the traveling of the consumer 102 to a new location, such as hours, days, weeks, etc. later. For instance, the consumer 102 may travel to a new country, and then use their registered payment card 104 to conduct a payment transaction a number of days or weeks later, prior to traveling to another new location.

In step 414, the receiving unit 202 of the processing server 108 may receive an authorization request for the payment transaction initiated by the consumer 102. The authorization request may be a transaction message formatted pursuant to one or more applicable standards that is received via the payment network 106 using applicable communication protocols. The authorization request may include a plurality of data fields, including at least a first data field that includes an account identifier associated with the payment card 104 used in the payment transaction and a second data field that includes a geographic location of the transaction. The transaction location may be a street address, country code, latitude and longitude, or other suitable representation of location. In some instances, the transaction location may be an identifier, such as associated with the merchant 110 or a point of sale device used in the payment transaction, for which the processing server 108 stores (e.g., in the memory 212) an associated geographic location.

In step 416, the processing unit 204 of the processing server 108 may identify an account profile 210 stored in the account database 208 that includes the account identifier included in the received authorization request. In step 418, the processing unit 204 may determine an authorization decision with respect to the geographic location. The authorization decision may be based on at least a correspondence between the transaction location and the current geographic location stored in the identified account profile 210. In some embodiments, the authorization decision may also incorporate additional considerations that will be apparent to persons having skill in the relevant art, such as fraud rules or algorithms, transaction data, etc. In step 420, the transmitting unit 206 of the processing server 108 may forward the authorization request to a financial institution associated with the transaction account associated with the account identifier along with the authorization decision. In some instances, the authorization decision may be incorporated in the authorization request, such as included in a data field stored therein. The financial institution may then decide to approve or deny the payment transaction based on, at least in part, the processing server's determination that utilizes the consumer's geographic location based on roaming data of their mobile communication device 112 upon entry into a new area and a geographic location of the transaction.

### Exemplary Method for Using Mobile Device Roaming Data to Determine Consumer Geolocation for Use in Authorization Decisions

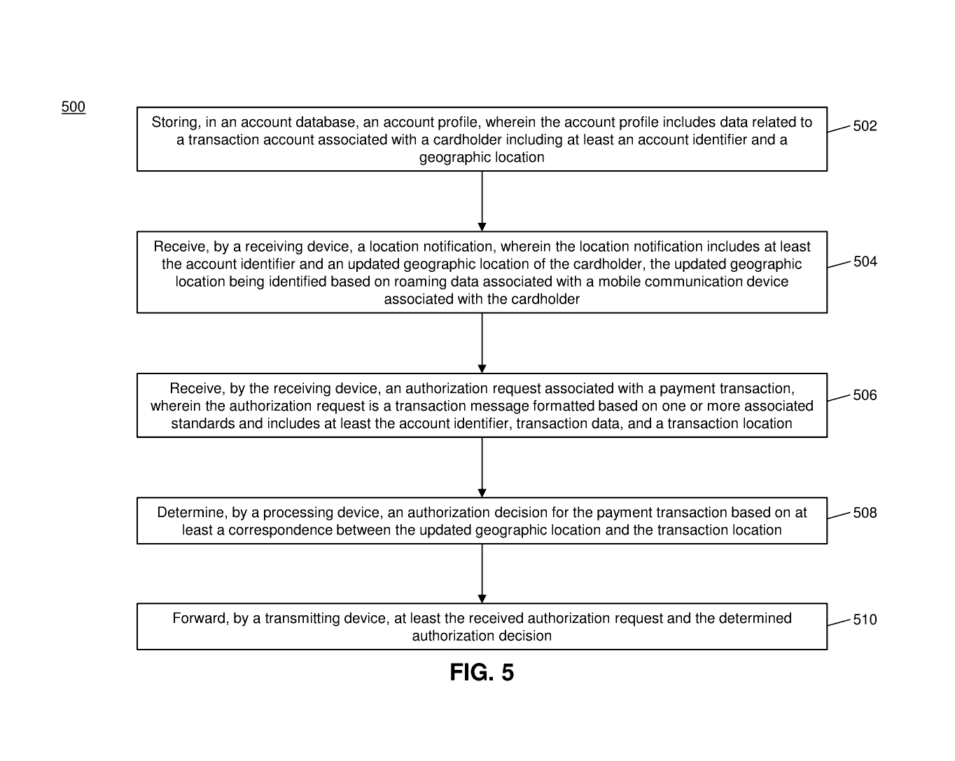

FIG. 5 illustrates a method 500 for the use of a consumer geographic location, determined using roaming data of an associated mobile communication device, in determining a decision regarding authorization of a payment transaction based on the transaction's geographic location.

In step 502, an account profile (e.g., account profile 210) may be stored in an account database (e.g., the account database 208), wherein the account profile 210 includes data related to a transaction account associated with a cardholder (e.g., the consumer 102) including at least an account identifier and a geographic location.

In step 504, a location notification may be received by a receiving device (e.g., the receiving unit 202), wherein the location notification includes at least the account identifier and an updated geographic location of the cardholder 102, the updated geographic location being identified based on roaming data associated with a mobile communication device (e.g., the mobile communication device 112) associated with the account profile 210 of the cardholder 102. In some embodiments, the account profile 210 may further include a device identifier, and the mobile communication device 112 may be associated with the device identifier included in the account profile 210. In a further embodiment, the device identifier may include at least one of: a phone number, registration number, serial number, unique device identifier, and media access control address. In one embodiment, the roaming data associated with the mobile communication device 112 is identified upon entry of the mobile communication device 112 in the updated geographic location.

In step 506, an authorization request associated with a payment transaction may be received by the receiving device 202, wherein the authorization request is a transaction messaged formatted based on one or more associated standards and includes at least the account identifier, transaction data, and a transaction location. In one embodiment, the transaction location may be included in a data element configured to store a country code. In some embodiments, the updated geographic location may be a country or set of countries and wherein the transaction location is the country or included in the set of countries. In one embodiment, the account identifier may be included in the authorization request in a data element configured to store a primary account number. In some embodiments, the location notification may be received prior to receipt of the authorization request.

In step 508, an authorization decision for the payment transaction may be determined by a processing device (e.g., the processing unit 204) based on at least a correspondence between the updated geographic location and the transaction location. In step 510, at least the received authorization request and the determined authorization decision may be forwarded by a transmitting device (e.g., the transmitting unit 206). In one embodiment, the determined authorization decision may be forwarded as part of the authorization request. In some embodiments, the method 500 may further include updating, by the processing device 204, the geographic location included in the account profile 210 based on the updated geographic location included in the received location notification.

### Computer System Architecture

FIG. 6 illustrates a computer system 600 in which embodiments of the present disclosure, or portions thereof, may be implemented as computer-readable code. For example, the processing server 108 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for using mobile device roaming data to determine consumer geolocations for use in authorization decisions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for using mobile device roaming data to determine consumer geolocation for use in authorization decisions, comprising:
storing, in an account database, an account profile, wherein the account profile includes data related to a transaction account associated with a cardholder including at least an account identifier and a geographic location;
receiving, by a receiving device, a location notification, wherein the location notification includes at least the account identifier and an updated geographic location of the cardholder, the updated geographic location being identified based on roaming data associated with a mobile communication device associated with the cardholder;
receiving, by the receiving device, an authorization request associated with a payment transaction, wherein the authorization request is a transaction message formatted based on one or more associated standards and includes at least the account identifier, transaction data, and a transaction location;
determining, by a processing device, an authorization decision for the payment transaction based on at least a correspondence between the updated geographic location and the transaction location; and
forwarding, by a transmitting device, at least the received authorization request and the determined authorization decision.

2. The method of claim 1, wherein the determined authorization decision is forwarded as part of the authorization request.

3. The method of claim 1, wherein the transaction location is included in a data element configured to store a country code.

4. The method of claim 1, wherein the updated geographic location is a country or set of countries and wherein the transaction location is the country or included in the set of countries.

5. The method of claim 1, wherein the account identifier is included in the authorization request in a data element configured to store a primary account number.

6. The method of claim 1, wherein
the account profile further includes a device identifier, and
the mobile communication device is associated with the device identifier included in the account profile.

7. The method of claim 6, wherein the device identifier includes at least one of: a phone number, registration number, serial number, unique device identifier, and media access control address.

8. The method of claim 1, wherein the roaming data associated with the mobile communication device includes is identified upon entry of the mobile communication device in the updated geographic location.

9. The method of claim 1, wherein the location notification is received prior to receipt of the authorization request.

10. The method of claim 1, further comprising:
updating, by the processing device, the geographic location included in the account profile based on the updated geographic location included in the received location notification.

11. A system for using mobile device roaming data to determine consumer geolocation for use in authorization decisions, comprising:
an account database configured to store an account profile, wherein the account profile includes data related to a transaction account associated with a cardholder including at least an account identifier and a geographic location;
a receiving device configured to receive
a location notification, wherein the location notification includes at least the account identifier and an updated geographic location of the cardholder, the updated geographic location being identified based on roaming data associated with a mobile communication device associated with the cardholder, and
an authorization request associated with a payment transaction, wherein the authorization request is a transaction message formatted based on one or more associated standards and includes at least the account identifier, transaction data, and a transaction location;
a processing device configured to determine an authorization decision for the payment transaction based on at least a correspondence between the updated geographic location and the transaction location; and
a transmitting device configured to forward at least the received authorization request and the determined authorization decision.

12. The system of claim 11, wherein the determined authorization decision is forwarded as part of the authorization request.

13. The system of claim 11, wherein the transaction location is included in a data element configured to store a country code.

14. The system of claim 11, wherein the updated geographic location is a country or set of countries and wherein the transaction location is the country or included in the set of countries.

15. The system of claim 11, wherein the account identifier is included in the authorization request in a data element configured to store a primary account number.

16. The system of claim 11, wherein
the account profile further includes a device identifier, and
the mobile communication device is associated with the device identifier included in the account profile.

17. The system of claim 16, wherein the device identifier includes at least one of: a phone number, registration number, serial number, unique device identifier, and media access control address.

18. The system of claim 11, wherein the roaming data associated with the mobile communication device includes is identified upon entry of the mobile communication device in the updated geographic location.

19. The system of claim 11, wherein the location notification is received prior to receipt of the authorization request.

20. The system of claim 11, wherein the processing device is further configured to update the geographic location included in the account profile based on the updated geographic location included in the received location notification.
